(19) United States
(12) Patent Application Publication
(10) Pub. No.: US 2021/0355713 A1
(43) Pub. Date: Nov. 18, 2021

(54) SYSTEM FOR SECURING ITEMS OF MERCHANDISE FROM THEFT

(71) Applicant: InVue Security Products Inc., Charlotte, NC (US)

(72) Inventors: Jeffrey A. Grant, Charlotte, NC (US); Christopher J. Fawcett, Charlotte, NC (US); David N. Berglund, Indian Trail, NC (US)

(21) Appl. No.: 17/319,883

(22) Filed: May 13, 2021

Related U.S. Application Data
(60) Provisional application No. 63/044,107, filed on Jun. 25, 2020.
(60) Provisional application No. 63/024,898, filed on May 14, 2020.

(51) Int. Cl. E05B 73/00

(52) U.S. Cl. CPC E05B 73/0011; G08B 13/1445; E05B 73/0082

(57) ABSTRACT

Embodiments of the present invention are directed to a system, devices, and methods for securing an item of merchandise. In one example, the system includes a tether configured to be secured to an item of merchandise, wherein the tether is a chain. The system also includes a housing configured to receive the tether, the tether configured to be extended and retracted relative to the housing and a reel disposed within the housing and configured to rotate for winding the tether on and off the reel.

### FIELD OF THE INVENTION

This application is a non-provisional of and claims the benefit of priority to U.S. Provisional Application No. 63/044,107, filed on Jun. 25, 2020, and to U.S. Provisional Application No. 63/024,898, filed on May 14, 2020, the entire contents of which are hereby incorporated by reference.

### FIELD OF THE INVENTION

Embodiments of the present invention relate generally to systems, devices, and methods for displaying and protecting items of merchandise, such as consumer electronics products, from theft.

### BACKGROUND OF THE INVENTION

It is common practice for retailers to provide demonstration models of consumer electronics products, such as handheld devices, tablets, and laptop computers, so that a potential purchaser may examine the product more closely and test the operation of its features. A working demonstration model, however, increases the possibility that the demonstration model will be stolen or removed from the display area by an unauthorized person. As a result, demonstration models of consumer electronics products are typically protected by a security device that permits a potential purchaser to examine and operate the product, while reducing the likelihood that the demonstration model will be stolen or removed from the display area.

### BRIEF SUMMARY

Embodiments of the present invention are directed towards systems and methods for securing an item of merchandise from theft. In one embodiment, a system is provided and includes a tether configured to be secured to an item of merchandise, the tether comprising a chain, and a housing configured to receive the tether, the tether configured to be extended and retracted relative to the housing. The system also includes a reel disposed within the housing and configured to rotate for winding the tether on and off the reel.

In one embodiment, a system is provided and includes a tether configured to be secured to an item of merchandise and a housing configured to receive the tether, the tether configured to be extended and retracted relative to the housing. The system further includes a reel disposed within the housing and configured to rotate about a first axis for winding the tether on and off the reel and a rotatable element disposed within the housing and configured to house the reel, the rotatable element configured to rotate about a second axis within the housing, the first axis being different than the second axis.

In another embodiment a method is provided and includes securing a tether to an item of merchandise, the tether comprising a chain. The method also includes extending and retracting the tether relative to a housing configured to receive the tether, a reel disposed within the housing and configured to rotate for winding the tether on and off the reel as the tether is extended and retracted.

### BRIEF DESCRIPTION OF THE DRAWINGS

FIG. 1 illustrates one embodiment of a system for securing an item of merchandise from theft.

FIG. 2 is perspective view of a sensor lifted off of a housing according to one embodiment.

FIG. 3 is perspective view of a housing secured to the underside of a display surface according to one embodiment.

FIG. 4 is partial view of the housing shown in FIG. 3 illustrating a reel and a mechanism configured to extend and/or retract the tether relative to the housing.

FIG. 5 is a perspective view of a housing including a rotatable element configured to rotate about the Z-axis according to one embodiment.

FIG. 6 is a partial view of the housing shown in FIG. 5 illustrating a reel and the rotatable element.

FIG. 7 is another partial view of the housing shown in FIG. 5 illustrating the reel and the rotatable element.

FIG. 8 is another partial view of the housing shown in FIG. 5 illustrating the reel and the rotatable element.

FIG. 9 is another partial view of the housing shown in FIG. 5 illustrating the reel and the rotatable element.

FIG. 10 illustrates a tether according to one embodiment.

### DETAILED DESCRIPTION OF EMBODIMENTS OF THE INVENTION

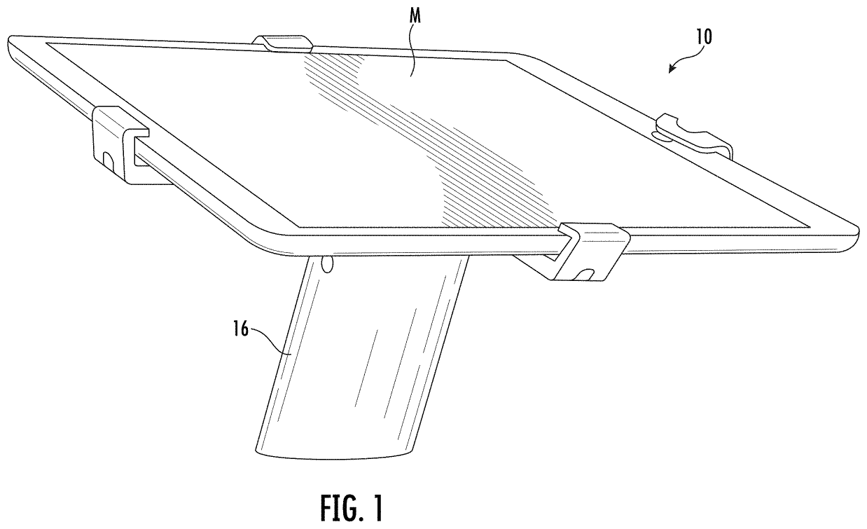

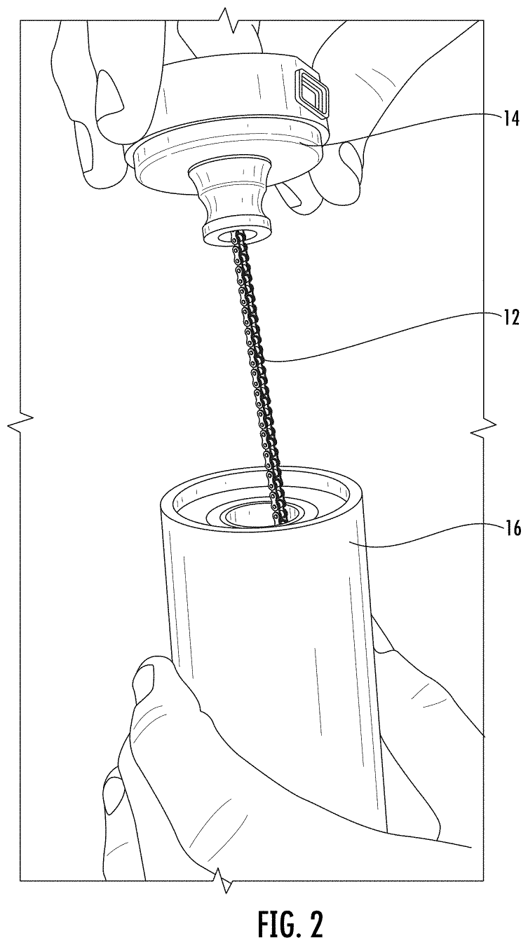

Referring to the accompanying figures wherein identical reference numerals denote the same elements throughout the various views, embodiments of systems, devices, and methods for displaying and protecting an item of merchandise against theft or unauthorized removal are provided. The item of merchandise may be any item, including any number of consumer electronics products (e.g., a hand-held device, cellular phone, smart phone, tablet, laptop computer, etc.). According to the embodiments shown in FIGS. 1 and 2, a system 10 is operable for securing an item of merchandise to a display support, surface, or the like, while at the same time permitting a potential purchaser to closely examine and operate the item of merchandise in a display area (e.g., a retail store). The system 10 permits a potential purchaser to examine and test the item of merchandise in a retail environment, while reducing the likelihood that the item of merchandise will be stolen or removed from the display area by an unauthorized person. However, the system 10 shown and described herein is suitable for engaging and securing an item of merchandise or other objects in a residential or commercial environment, among others, as well as any application where a tether is extended and retracted.

In one embodiment, the system 10 includes a tether 12 configured to be secured to an item of merchandise M with a sensor 14 at one end and a housing 16 configured to receive the tether at an opposite end. The sensor 14 is configured to be secured to the item of merchandise M with adhesive and/or mechanical brackets (see, e.g., FIG. 1). The tether 12 is configured to be extended and retracted relative to the housing 16. The system 10 also includes a mechanism 18 coupled to the tether 12 that is configured to extend and/or retract the tether relative to the housing 16. In some embodiments, the mechanism 18 is configured to automatically extend and/or retract the tether. For example, the mechanism 18 may be a recoiler having a spring configured to retract the tether 12 into the housing 16, while a customer is able to overcome the spring force to extend the tether out of the housing. The spring could be loaded as the tether 12 is extended out of the housing 16 such as, for example, via a torsion spring, a tension spring, or the like.

The tether 12 may be used to mechanically secure the item of merchandise to a display surface 22, support, or the like. In this regard, one end of the tether 12 may be coupled to the item of merchandise M, while the opposite end of the tether may be secured to the housing 16. The tether 12 may be secured directly to the item of merchandise M or could be secured to a sensor 14 that is in turn secured to the item of merchandise. In one embodiment, one end of the tether 12 may be fixed within or to the housing 16 such that this end does not move when the remaining portion of the tether is extended or retracted from the housing. The tether 12 is coupled in such a way for allowing the length of the tether to be adjusted relative to the housing 16 as the customer interacts with the item of merchandise M. Thus, a customer is able to extend the tether 12 from the housing 16 to inspect an item of merchandise, and the tether is retracted within the housing when the item of merchandise is returned to the housing 16 or display surface 22.

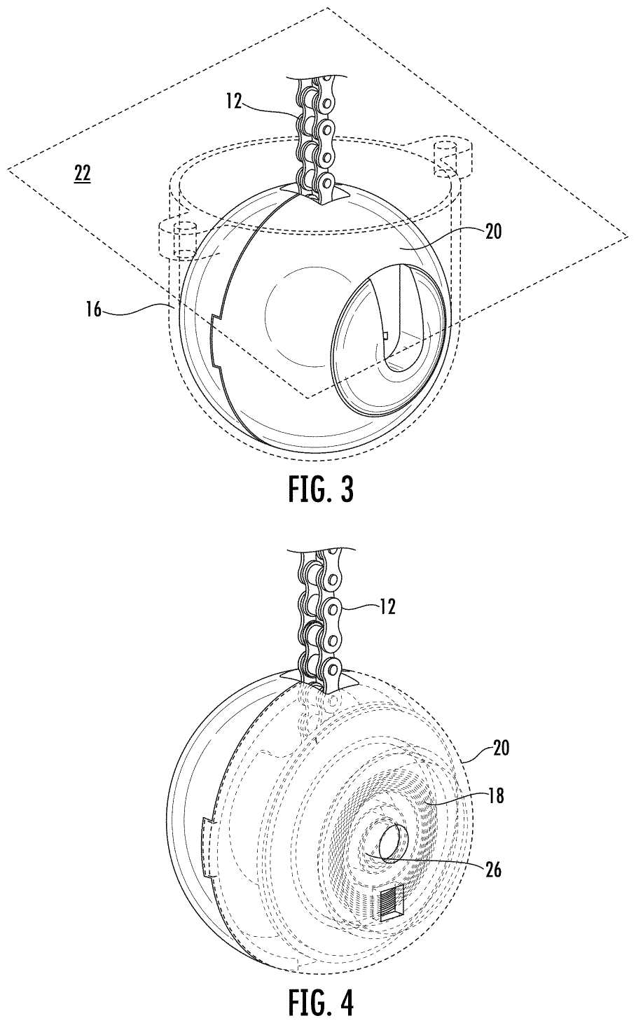

The housing 16 may be a base or stand that is configured to removably support the sensor 14 and the item of merchandise M thereon. The housing 16 may be further configured to be secured or fixed to the top of the display surface 22 (see, e.g., FIG. 1). Alternatively, the housing 16 may be configured to be secured to the underside of the display surface 22 such that the housing is disposed below the display surface and out of sight of customers, while the tether 12 is configured to extend through an opening in the display surface so that customer may interact with the item of merchandise M (see, e.g., FIGS. 3-4). In other embodiments, the housing 16 may include upper and lower portions, wherein the upper portion is configured to engage a display surface 22. For instance, the upper portion of the housing 16 may be configured to engage the lower portion of the housing. It is understood that the housing 16 may be any suitable size and configuration to accommodate the tether 12, a rotatable element 20, and mechanism 18, as well as facilitate engagement with a display support or surface 22.

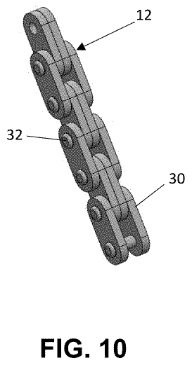

In one embodiment, the tether 12 is a chain, such as a roller chain. The tether 12 may be similar to a bike chain in one example. The tether 12 may include a plurality of links comprised of outer and inner plates, pins, bushings, and rollers that are linked together to form a length of chain. In some cases, bushings may be omitted. Typically, the bushings and rollers are sandwiched between the inner and outer plates to define roller links and secured together with pin links. In another embodiment shown in FIG. 10, the tether 12 may be non-conventional in that the inner and outer plates do not have voids for receiving a sprocket therein which may increase tensile and shear strength. The tether 12 may also not have any rollers and/or bushings. For example, the tether 12 shown in FIG. 10 includes a series of plates 30 connected by pins 32 which may simplify the manufacturing and improve cut resistance. In some cases, the plates 30 may be the same size and configuration (e.g., oval in shape) whereby one or more plates are sandwiched between inner and outer plates and interconnected with pins 32. The tether 12 may be formed of a metal material, such as steel, having cut-resistant properties, and may be hardened and/or coated for durability. The tether 12 may be flexible to facilitate extension out of and retraction within the housing 16, as well as winding on and winding off of a reel 26. The tether 12 can be any desired size, pitch, and/or length depending on the application desired. In some embodiments, the pin links may have larger heads than conventional pins to prevent the pin links from being defeated, such as by using a tool to remove the pin links. For example, the pin links could be enlarged rivets on either or both sides of the links to prevent removal or fasteners (e.g., a proprietary fastener requiring a proprietary tool for removal).

In one embodiment, the housing 16 is configured to receive at least a portion of the tether 12 therein. In the example shown in FIGS. 3-4, the housing 16 is also configured to at least partially receive and house a rotatable element 20 and other components of the system 10, including a retraction mechanism 18 (e.g., a spring). The tether 12 may be configured to be wound onto and unwound from a reel or spool 26. One end of the tether 12 may be secured to the rotatable reel 26. The rotatable reel 26 may be operably engaged with the tether 12 such that rotation of the reel in one direction causes the tether to unwind from the rotatable reel and to extend out of the housing 16, while rotation of the reel in an opposite direction results in the tether being retracted into the housing and wound about the rotatable reel. In some cases, the tether 12 may be configured to wrap upon itself as the tether is wound onto the reel 26.

The rotatable element 20 may be configured to rotate within the housing 16 in some embodiments. For example, the rotatable element 20 and housing 16 may function similar to a “ball-and-socket” configuration and be configured to rotate with multiple degrees of freedom. Thus, as a load is applied to the tether 12 (e.g., due to a consumer lifting the item of merchandise M from the housing 16), the rotatable element 20 may rotate within the housing. In particular, the rotatable element 20 may be configured to rotate in response to a side load applied to the tether 12 which may help prevent failure of the tether, such as a result of an attempted theft. As shown in FIG. 4, the rotatable element 20 may contain or house the reel 26 such that the entire assembly is configured to rotate in unison. FIG. 4 also shows that the rotatable element 20 may be spherical in shape in some embodiments, with the housing 16 defining a corresponding spherical opening for containing the rotatable element therein.

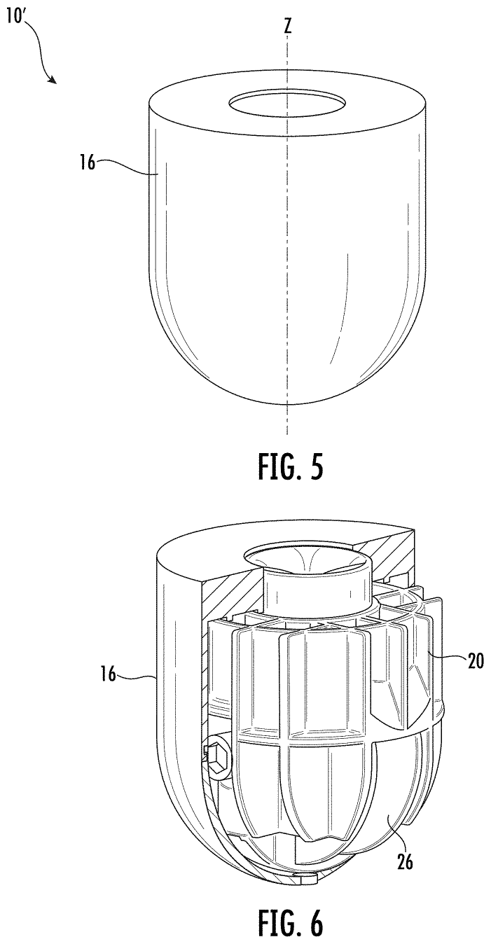

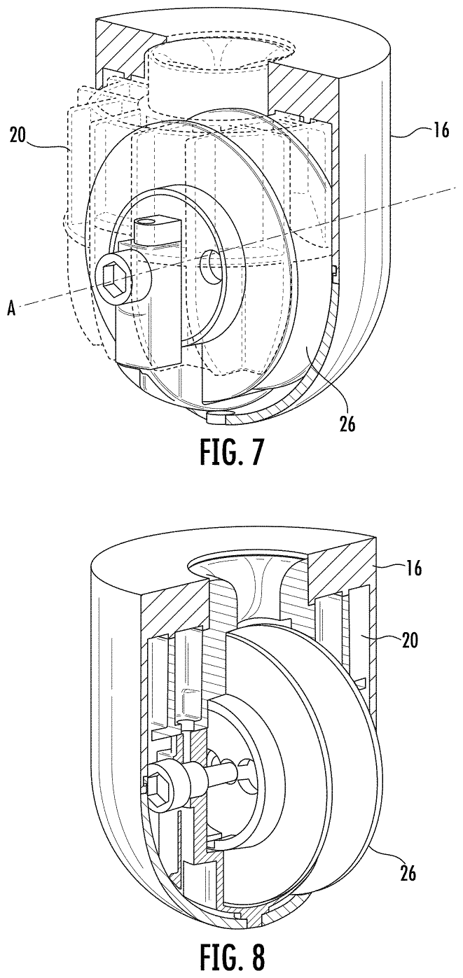

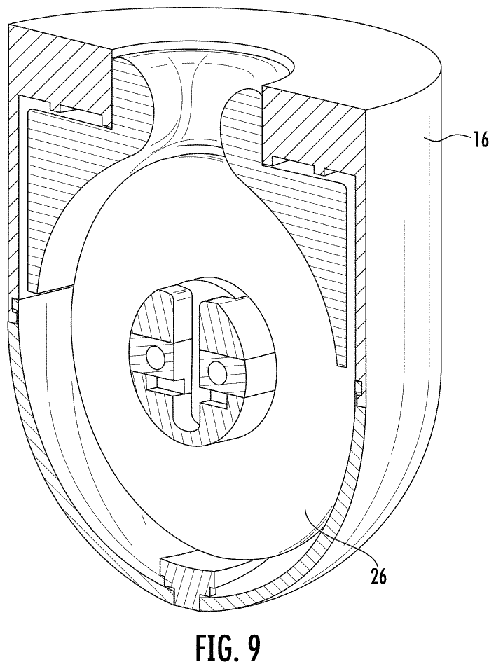

In other embodiments, the rotatable element 20 may be configured to rotate about at least one axis within the housing 16. As noted above, the rotatable element 20 may rotate about multiple degrees of freedom in a ball-in-socket configuration (e.g., at least an X, Y, and Z axis). In another embodiment of a security system 10′ shown in FIGS. 5-9, the rotatable element 20 is configured to rotate about the Z-axis, which in this case corresponds to the longitudinal axis of the tether 12 exiting the housing 16. The reel 26 may be fixed to the rotatable member 20 such that the reel is also configured to rotate about the Z-axis. In this embodiment, the reel 26 is configured to rotate about another axis for allowing the tether 12 to wind on and off of the spool (e.g., an axis “A” perpendicular to the Z-axis). In the illustrated embodiment, the rotatable member 20 is hemi-spherical in shape.

In one embodiment of a security system 10, the tether 12 is in operable communication with an alarm unit. For example, an alarm unit may be operably engaged with the tether 12 and configured to detect that the tether has been severed and/or separated from the sensor 14 and/or the housing 16. The alarm unit may be disposed within, on, or below a display surface 22, housed by the sensor 14, or housed by the housing 16 (or each of the sensor and housing may include its own alarm unit). In one example, the tether 12 may be configured to conduct a sense signal, and interruption of the sense signal (e.g., cutting the tether) may be detectable by the alarm unit. The tether 12 may be configured to communicate a sense signal along its length such as by acting as an antenna to facilitate communication between the sensor 14 and the housing 16. In addition, removal of the item of merchandise M from a sensor 14 may result in an alarm. Thus, the security system 10 may include a sensor 14 having a sensor element electrically coupled to an alarm unit for monitoring the sensor element and for activating an audible and/or visible alarm in the event that the item of merchandise M is separated (e.g., detached) from the sensor.

The system 10 may further include a power mechanism for powering the sensor 14 and/or the item of merchandise. For example, the housing 16 may be in electrical communication with a power source, and the housing may be configured to transfer power to the sensor 14 and/or the item of merchandise M, such as via inductive or contact charging between the housing and the sensor. In addition, the system 10 may include an arming/disarming device, such as a key for arming and/or disarming the alarm unit. In one embodiment, the key is capable of wireless communication for arming and/or disarming the alarm unit, such as an infrared key configured to arm/disarm the alarm with a unique security code.

Therefore, embodiments of the present invention may provide advantages over conventional tethers. In this regard, even with thick threaded steel cables, cut resistance to a pair of typical hand-held cutters is low, requiring minimal time to sever. There is a trade-off between cut-resistance and user experience. The bigger the cable, the more difficult it is to wind around a spool, leading to increased spring force or eliminating the spool, which requires additional space inside the fixture for the cable to go, or using a very short cable, inhibiting the user's ability to lift the item of merchandise. Large cables also make the housing that is holding the spool larger than desired. Using a roller chain as a tether may solve many of these problems. First, being formed of thicker pieces of solid steel vs. threaded wire cable makes it harder to cut through. Second, the hinge joints on a roller chain allow it to wrap around a smaller spool diameter than a threaded cable with very little force. Also, a roller chain tether can fit more length on a spool compared to a threaded wire cable because the spool diameter can be smaller than with the wire cable. These traits lead to more length of tether in a tighter space, decrease total housing size. Moreover, use of a rotatable member within the housing may lessen the likelihood that a would-be thief would be able to defeat the tether using a side load applied to the tether.

The foregoing has described as one or more embodiments of a system and method for securing an item of merchandise. Although various embodiments of the present invention have been shown and described, it will be apparent to those skilled in the art that various modifications thereto can be made without departing from the spirit and scope of the invention. Accordingly, the foregoing description is provided for the purpose of illustration only, and not for the purpose of limitation.

That which is claimed is:

1. A system for securing an item of merchandise from theft, the system comprising:
a tether configured to be secured to an item of merchandise, the tether comprising a chain;
a housing configured to receive the tether, the tether configured to be extended and retracted relative to the housing; and
a reel disposed within the housing and configured to rotate for winding the tether on and off the reel.

2. The system of claim 1, further comprising a sensor coupled to an end of the tether, the sensor configured to be attached to the item of merchandise and configured to detect detachment of the item of merchandise from the sensor.

3. The system of claim 2, wherein the housing comprises a base configured to removably support the sensor and the item of merchandise thereon.

4. The system of claim 1, wherein the chain is a roller chain.

5. The system of claim 1, further comprising a rotatable element at least partially disposed within the housing and configured to house the reel, the rotatable element configured to rotate within the housing.

6. The system of claim 5, wherein the rotatable element is configured to rotate about at least one axis of rotation.

7. They system of claim 6, wherein the reel is configured to rotate about an axis that is perpendicular to the at least one axis of rotation.

8. The system of claim 6, wherein the at least one axis of rotation corresponds to a longitudinal axis of the tether.

9. The system of claim 5, wherein the rotatable element is spherical or hemi-spherical in shape.

10. The system of claim 1, wherein the chain is entirely formed of metal.

11. The system of claim 1, further comprising a spring operably engaged with the reel and configured to retract the tether into the housing and onto the reel.

12. The system of claim 1, wherein the tether is configured to wrap upon itself when wound on the reel.

13. The system of claim 1, wherein an entire length of the tether comprises a chain.

14. The system of claim 1, wherein the housing is configured to be mounted below a display surface and the tether is configured to be extended and retracted through an opening defined in the display surface.

15. A system for securing an item of merchandise from theft, the system comprising:
a tether configured to be secured to an item of merchandise;
a housing configured to receive the tether, the tether configured to be extended and retracted relative to the housing;
a reel disposed within the housing and configured to rotate about a first axis for winding the tether on and off the reel; and
a rotatable element at least partially disposed within the housing and configured to house the reel, the rotatable element configured to rotate about a second axis within the housing, the first axis being different than the second axis.

16. The system of claim 15, wherein the tether comprises a chain.

17. The system of claim 16, wherein an entire length of the tether comprises a chain.

18. The system of claim 15, wherein the first axis is perpendicular to the second axis.

19. The system of claim 15, wherein the second axis corresponds to a longitudinal axis of the tether.

20. A method for securing an item of merchandise from theft, the method comprising:
securing a tether to an item of merchandise, the tether comprising a chain; and
extending and retracting the tether relative to a housing configured to receive the tether, a reel disposed within the housing and configured to rotate for winding the tether on and off the reel as the tether is extended and retracted.
